(19) United States
(12) Patent Application Publication
(10) Pub. No.: US 2003/0031984 A1
(43) Pub. Date: Feb. 13, 2003

(54) CERAMIC DENTAL MILL BLANKS

(76) Inventors: RICHARD P. RUSIN, WOODBURY, MN (US); JAMES D. HANSEN, PASADENA, CA (US)

Correspondence Address: ARLENE L HORNILLA, OFFICE OF INTELLECTUAL PROPERTY COUNSEL, 3M INNOVATIVE PROPERTIES COMPANY, P O BOX 33427, ST PAUL, MN, 551333427

(21) Appl. No.: 09/383,560

(22) Filed: Aug. 26, 1999

(51) Int. Cl. A61C 5/00

(52) U.S. Cl. 433/215

(57) ABSTRACT

This invention provides light transmissive crystalline ceramic dental mill blanks and prostheses having a Contrast Ratio value of less than about 0.7. The dental mill blank is suitable for fabricating into an aesthetic restoration or prosthesis.

### FIELD OF THE INVENTION

This invention relates broadly to dental mill blanks that may be used to create dental prostheses by hand-held instruments or computer automated machining. Specifically, the mill blanks of the invention are light transmissive to provide aesthetically pleasing dental prostheses.

### BACKGROUND

Although performance and durability of dental materials are highly desirable characteristics of dental replacement and repair work, they alone are not the sole concern for practitioners and patients. Aesthetic value, or how dental materials look inside the mouth is just as desirable. For example, in prosthodontics and restorative dentistry, where tooth replacement, or prostheses, are custom made to fit in or on a tooth structure there are instances where the restoration or repair can be seen from a short distance when the mouth is open. Thus in those instances, it would be highly desired that the dental material be nearly indistinguishable from adjacent tooth structure.

Prosthetics and restorative dentistry encompass the fabrication and installation of, for example, restoratives, replacements, inlays, onlays, veneers, full and partial crowns, bridges, implants, and posts. Conventional materials used to make dental prostheses include gold, ceramics, amalgam, porcelain and composites. In terms of aesthetic value, it is perceived that porcelains, composites and ceramics look better than amalgam and metals, since a prosthetic made from those non-metals better matches or blends in with the color of adjacent natural teeth.

Various processes and procedures for creating or fabricating prostheses are now available to practitioners. Typically, a prosthesis is produced from a cast model made to replicate a dentition. With numerous subsequent adjustments and material alterations, a proper fit and comfort can ultimately be achieved. New and more efficient methods, however, are emerging whereby computer automated equipment is programmed to machine a blank into a precise prosthesis. This is frequently referred to as “digital dentistry,” where computer automation is combined with optics, digitizing equipment, CAD/CAM (computer-aided design/computer aided machining) and mechanical milling tools. Examples of such a computer-aided milling machine include the CEREC 2™ machine supplied by Siemens (available from Sirona Dental Systems; Bensheim, Germany); VITA CELAY™ (available from Vita Zahnfabrik; Bad Säckingen, Germany); PRO-CAM™ (Intra-Tech Dental Products, Dallas, Tex.); and PROCERA ALLCERAM™ (available from Nobel Biocare USA, Inc.; Westmont, Ill.). U.S. Pat. Nos. 4,837,732 and 4,575,805 also disclose the technology of computer-aided milling machines for making dental prostheses. These machines produce dental prostheses by cutting, milling, and grinding the near-exact shape and morphology of a required restorative with greater speed and lower labor requirements than conventional hand-made procedures.

Fabrication of a prosthesis using a CAD/CAM device requires a “mill blank,” a solid block of material from which the prosthesis is cut or carved. The mill blank is typically made of ceramic material. U.S. Pat. No. 4,615,678 discloses a blank adapted for use in machine fabrication of dental restorations comprising a ceramic silica material. Other mill blanks suitable for milling in a CAD/CAM dental milling machine are disclosed in, for example, U.S. Pat. Nos. 5,151,044 and 5,342,696. There exist various mill blanks available commercially, including VITA CELAY™ porcelain blanks Vita Mark II Vitablocks™ and VITA IN-CERAM™ ceramic blanks (each available from Vita Zahn Fabrik; Bad Säckingen, Germany). Machinable micaceous ceramic blanks (e.g. Corning MACOR™ blanks and Dentsply DICOR™) are also known. These materials, however, require a practitioner or laboratory to hold a large inventory of blanks in various shades due to their opacity and pre-determined color/shading. It would therefore be advantageous to have a mill blank with no pre-determined color and the ability to blend with or color-match the dentition surrounding the milled prosthesis. Providing such a mill blank would eliminate the need for having a large inventory of blanks in varying colors and shades, and give the practitioner the flexibility to color-match a prosthesis with the use of just one mill blank.

### SUMMARY OF THE INVENTION

The present invention provides crystalline ceramic mill blanks and dental prostheses that have a Contrast Ratio value of less than about 0.7. The blanks are suitable for fabricating into dental prostheses or restorations. Preferably, the blanks, before and after being milling into a prosthesis, have a flexural strength greater than about 250 MPa.

The mill blanks and a prosthesis made from the blanks according to the invention are light transmissive and therefore are able to blend and match the dentition that surrounds the prosthesis. Thus, these mill blanks provide material from which an aesthetically-pleasing prosthesis may be made. Color and shade matching can optionally be accomplished by use of a color/shade-matching composition such as a luting or bonding agent.

Preferably, the mill blanks and prostheses of the invention are essentially free of glass and oxy-nitride. The ceramic is preferably polycrystalline and high (at least about 99% theoretical) density.

### BRIEF DESCRIPTION OF THE DRAWINGS

Those skilled in the art may recognize that various modifications and additions may be employed in connection with the specific, presently preferred embodiments described and illustrated below in the accompanying drawings. As such, the invention should not be deemed limited to the particular embodiments set out in detail, but instead only by a fair scope of the claims that follow along with their equivalents.

FIG. 1 is a perspective view of a crystalline ceramic mill blank according to one embodiment of the invention, where the mill blank is substantially cylindrical.

FIG. 2 is a perspective view of a crystalline ceramic mill blank according to another embodiment of the invention, where the mill blank is bar-shaped and has a rectangular cross-section.

FIG. 3 is a perspective view of a crystalline ceramic mill blank according to another embodiment of the invention, where the mill blank is suitable for milling into a double-lobed prosthesis.

FIG. 4 is a perspective view of a crystalline ceramic mill blank according to another embodiment of the invention, wherein the mill blank comprises a crystalline ceramic body attached to a mounting or support stub.

FIG. 5 is a perspective view of a crystalline ceramic mill blank according to another embodiment of the invention, where the ceramic body and mounting or support stub are in a unitary article.

### DESCRIPTION OF THE PREFERRED EMBODIMENTS

The dental mill blanks and prostheses made from mill blanks of the present invention are light transmissive. The phrase “light transmissive” is descriptive of the material's ability to allow light to pass through (they have a high degree of light transmittance in the visible spectrum) and can be quantified as having a Contrast Ratio value of less than about 0.7.

A light transmissive material is an advantage because a prosthesis milled from a light transmissive mill blank effectively blends in with its surroundings and assumes the color of the underlying tooth and the teeth adjacent to it. Thus, a practitioner can easily color-match a milled prosthesis with the color and shade of the dentition that surrounds the prosthesis.

Yet another advantage of providing light transmissive mill blanks and prostheses is the elimination of the need for a practitioner or laboratory to carry a large range of pre-colored mill blanks. As is well known, human teeth have a broad range of color (quantified and illustrated, for example, by the commercially available Vita shade system covering the range A1 through D4). Thus, a light transmissive mill blank that can be color-matched to any surrounding could significantly reduce a practitioner's or laboratory's inventory of mill blanks.

Light transmissive mill blanks and prostheses also provide improved aesthetics as compared to more opaque materials. For example, a prosthesis, restoration, or repair placed in a location readily seen when a patient opens his or her mouth, would be more aesthetically pleasing if it were nearly indistinguishable and unnoticeable.

The Contrast Ratio value of a mill blank indicates the level of light transmissivity it possesses. Contrast Ratio values can be measured using a technique based on Section 3.2.1 of ASTM -D2805-95, modified for samples of about 1 mm thick. This test method is provided below. Lower values of Contrast Ratio indicate greater levels of light transmissivity. Mill blanks and prostheses according to the invention have a Contrast Ratio value less than about 0.7, preferably less than about 0.6, more preferably less than about 0.5.

Dental mill blanks of the invention also offer other desirable properties such as high flexural strength. Flexural strength can be measured according to the test methods described below. It is desirable that a dental material used for prostheses and restorations have high strength and reliable mechanical properties when machined into a complex shape and subjected to complex stresses.

Flexural strength indicates the ability for a mill blank and a milled prosthesis to withstand forces exerted on dentition and restoration. Surprisingly, materials of the present invention exhibit excellent flexural strength even after machining. Samples made from the mill blanks of the present invention, when testing using the test methods described below, possess a flexural strength greater than 250 MPa (mega pascal), preferably greater than about 350 MPa; more preferably greater than about 500 MPa. Having these strengths ensures that prostheses milled from mill blanks according to the invention are durable under typical use conditions. This is an advantage over prostheses milled or fabricated from other materials such as porcelain, which tend to be weaker.

Flexural modulus characterizes the stiffness of a material. It has been found that a prosthesis milled from a mill blank according to the invention typically possesses a flexural modulus of greater than about 70 GPa (giga pascal).

It has been surprisingly found that the mill blanks of the present invention provide mechanical properties desirable in dental prostheses materials, while being capable of rapid machining. Quite advantageously, the dental mill blanks of the invention can be readily formed or milled into a variety of dental devices such as restoratives, replacements, inlays, onlays, veneers, full and partial crowns, bridges, implants, and posts. These devices can be formed by hand using a hand-held tool or by a milling machine, such as those integrated with computer automated/assisted tooling (CAD/CAM). As used herein, “carving” means abrading, polishing, controlled vaporization, electronic discharge milling (EDM), cutting by water jet or laser or any other method of cutting, removing, shaping or milling material.

The dental mill blanks and prostheses of the invention comprise a crystalline ceramic. A “ceramic” refers to an inorganic nonmetallic material. As used herein, “crystalline” refers to material that shows crystalline diffraction peaks when subjected to a bulk powder x-ray diffraction scan and is essentially free of glass. It is preferred that the amount of glass in the blanks and prostheses of the invention is less than about 5 wt % of the total composition. More preferably, the amount of glass present is less than about 2 wt %, and most preferably, the mill blanks and prostheses are glass free (0 wt %). Glass content may be determined by the Rietveld technique (see Artioli, G. , Alberti, G. , Cagossi, G. , Bellatto M. (1991) “Quantitative determination of crystalline and amorphous components in clinoptilolite-rich rocks by Rietveld analysis of X-ray powder diffraction profiles”, in Atti 1 Convegno Italiano di Scienza e Technologia delle Zeoloti edited by C. Colella (De Frede, Napoli) pp 261-270; and Bellotto, M. and Cristiani, C. (1991) “Quantitative X-ray Diffraction Rietveld analysis of low coal ashes” Mater. Sci. Forum 79-82, pp745-750.) Analysis tools useful in this technique includes Siroquant™ computer software, available from Sietronics Group (Belconnen, Australia).

The crystalline ceramic may be either mono-crystalline (i.e. single, crystal) or polycrystalline. Polycrystalline ceramics include nanocrystalline materials and may be single phase or multiphase. As used herein, a “single phase” crystalline ceramic contains only one crystal structure, as identified by powder x-ray diffraction. A “multi-phase crystalline” ceramic contains more than one crystal structure. Preferably, the dental mill blank comprises at least 99% polycrystalline ceramic having at least 99% theoretical density.

The mill blanks and prostheses preferably have a neutral or tooth-like shade which, taken in combination with its ability to be light transmitting, makes a milled prosthesis nearly indistinguishable from surrounding dentition when it is placed in a mouth and viewed from a relatively short distance. Preferably, for optimum color-matching, the crystalline ceramic material is essentially colorless; i.e. it neither adds color to the light passing through nor subtracts color by appreciable absorption.

The ceramic material of the mill blanks and prostheses of the invention are chosen so as to provide the desired flexural strength and light transmissivity.

A preferred ceramic for the present invention is aluminum oxide. Aluminum oxide is desirable since it is strong, hard, transparent, has neutral color, and readily available. In addition, aluminum oxide is also particularly suitable since its optical transmittance is substantially constant throughout the visible spectrum and it therefore transmits all wavelengths of visible light. It is desirable that the aluminum oxide be high purity (preferably at least 99.5% purity) aluminum oxide for maximum strength and freedom from chromatic effects. If desired, up to about one percent magnesium oxide may be added to the aluminum oxide for aiding in sintering and enhancing the strength of the aluminum oxide. The most preferred light transmissive alumina materials are commercially available from Ceradyne, Inc. under the tradename TRANSTAR and General Electric under the tradename LUCALOX.

Where the crystalline ceramic mill blank or prosthesis comprises aluminum oxide, it is highly desired that only a small amount of residual porosity be present. Preferably, the crystalline ceramic mill blanks and prostheses are substantially non-porous (i.e. zero porosity) to maintain a high degree of optical transmittance. Furthermore, it is preferred that the average grain size of the aluminum oxide mill blank be in the range of about 5 to 50 micrometers, more preferably about 10 to 30 micrometers.

Other materials may be employed that also provide a light transmissive crystalline ceramic mill blank or prosthesis. Magnesium-aluminum spinel (MgAl₂O₄), zirconium oxide, yttrium aluminum garnet, zirconium silicate, yttrium oxide and mullite, for example, are crystalline materials suitable for the mill blanks of the invention. Additional information regarding these ceramic materials may be found in for example, U.S. Pat. Nos. 5,231,062; 5,096,862; 4,098,612; 4,174,973; and reference materials DeWith et al, “Solid State Ionics: Translucent Y₃Al₅O₁₂ Ceramic: Mechanical Properties” v.46 (1985) p.87-94; and Fang et al., “Materials Letters v.28 (1996), pp. 11-15.

The level of light transmissivity in crystalline ceramics is attained through careful selection of starting materials, additives and processing conditions. Details are provided in for example, U.S. Pat. No. 3,026,210 to Coble. In a preferred fabrication technique involving firing or sintering, conditions that are controlled and/or closely monitored include temperature, time, atmosphere and pressure.

Optionally, additives that may be included in the mill blanks and prostheses 10 include dopants and colorants. Colorants may be used to achieve desired shades of teeth include iron oxide, rare earth oxides (atomic number 57-71 inclusive), and bismuth oxide.

Additives to the invention that are preferably avoided include oxynitride and substantial amounts of glass to the extent that they have a measurably detrimental effect on the strength of the mill blanks and milled prostheses.

Various methods of making dental mill blanks of the present invention may be employed, including pressing and sintering, melt drawing, injection mold, hot pressing and extrusion processes. These processes are well known for their use in making ceramic materials.

Sintering for processing crystalline ceramic has been described in Kingery, Bowen, Uhlmann, “Introduction to Ceramics,” 2^{nd} ed., John Wiley, 1976, pp.448-515; “Engineered Materials Handbook: Volume 4 Ceramics and Glasses,” ASM International, 1991, pp. 243-312; and U.S. Pat. No. 3.026,210 to Coble. Where aluminum oxide mill blanks are made through sintering, it is preferred that the material be fully sintered to achieve greater than about 98% of the theoretical density of the ceramic material. More preferably, fully sintering achieves greater than about 99.0% theoretical density, and most preferably 99.5% theoretical density. The mill blanks can be fabricated by pressing powder to a desired shape and sintering the pressed compact at temperatures close enough to the material's melting point so that the ceramic coalesces and densities. In one such manufacturing technique, high purity aluminum oxide powder is placed in the die cavity of a high-pressure hydraulic press. Submicron size particles are used. This hot pressing accelerates the sintering process and allows one to achieve substantially theoretical density in the sintered compact.

The blank may be provided at near full density (>95% of theoretical). Alternatively, it may be provided with sufficient porosity as to facilitate rapid machining. After such a blank is milled, it may then be sintered to full density to provide a highly aesthetic prothesis. In this case, the blank is milled “oversize” to accommodate the shrinkage which may occur with sintering. Theoretical density for a crystalline ceramic is calculated from the atomic weights of the constituents and the volume of the crystallographic unit cell.

If desired, the inventive mill blank can be hot isostatic pressed (“HIP”) to accelerate the sintering process. In a press, isostatic pressure is applied while the material is heated to the sintering temperature. The combination of high temperature and high pressure compacts the HIPed part to have substantially zero porosity. U.S. Pat. No. 4,954,080 provides further discussion as to hot isostatic pressing aluminum oxide, the disclosure of which is incorporated by reference.

Yet another method for producing a rod of crystalline ceramic material is described in U.S. Pat. No. 4,639,218, which refers to an EFG (Edge-defined, Film-fed, Growth) modification of the Czochralski process for growing crystalline alpha-alumina. Alternatively, a hot forging method as described in U.S. Pat. No. 4,323,545 can also be used to produce the inventive mill blanks. A preferred method for synthesizing single crystals is described in U.S Pat. No. 4,639,218.

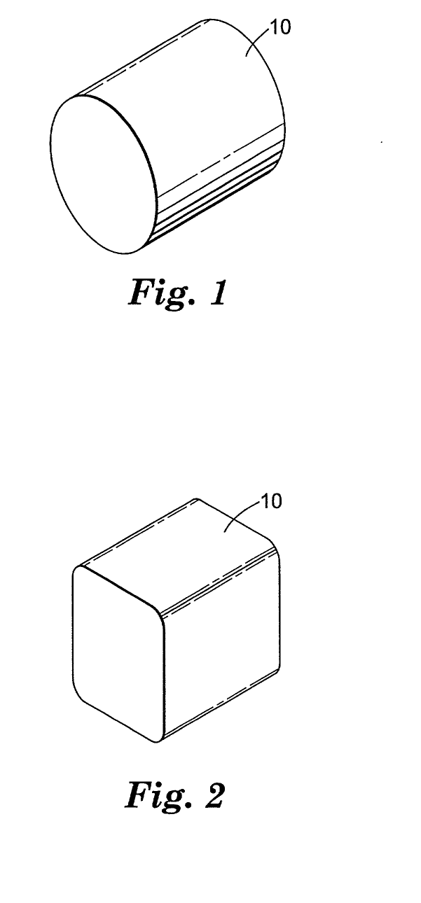

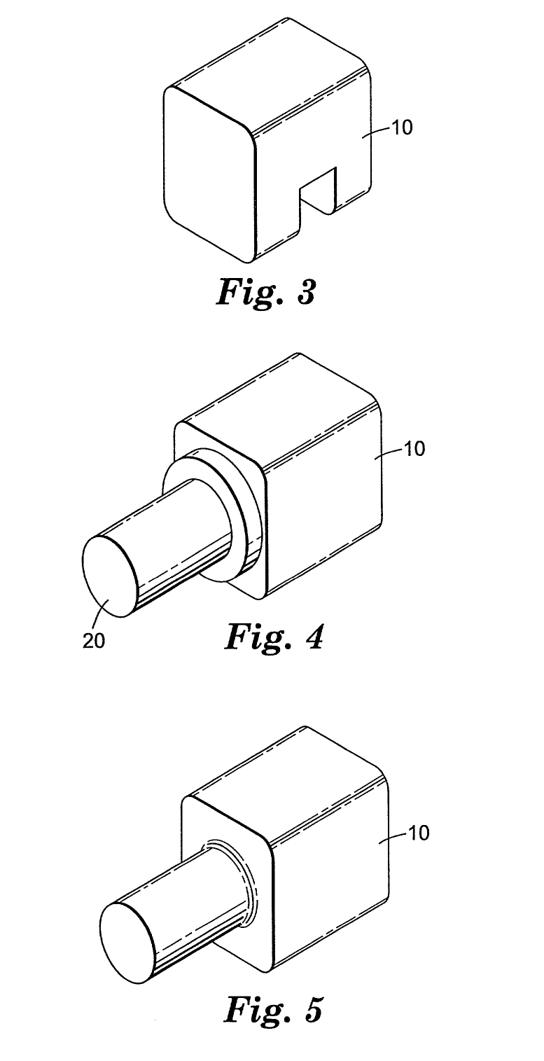

The dental mill blanks of the present invention may be made in any desired shape or size, including cylinders, bars, cubes, polyhedra, ovoids, and plates. Referring now to the drawings, FIG. 1 shows a preferred embodiment of the inventive blank, where blank 10 is substantially cylindrical. FIG. 2 depicts another preferred embodiment of the blank according to this invention, where blank 10 is shaped like a bar, having a rectangular cross-section. To minimize work time on a milling machine or hand-held tool, it may be desirable to shape the mill blank to more closely resemble the final prosthesis. For example, in the case of a double-lobed restoration, blank 10 could be made in the shape as depicted in FIG. 3. Thus, the blanks can come in a variety of shapes and sizes.

Referring now to FIG. 4, another preferred embodiment of a dental mill blank 10 is shown, which includes a mounting or support stub 20 to facilitate affixation of the blank in a milling machine. Stub 20 functions as a handle from which a blank is held by as it is milled by a machine. Depending on how the mill blank must be affixed in a milling machine, the mounting stub can be positioned on any side of the ceramic body (the machinable part of the mill blank). Stub 20 can be attached to the ceramic mill blank mechanically, by adhesive, or other means. Alternatively, as shown in FIG. 5, the ceramic body as well as the stub can be a unitary piece, whereby the stub is formed along with the machinable body of the mill blank.

Preferably, the outer surface of the blank is smooth and non-tacky.

The crystalline ceramic mill blanks of the invention are suitable for fabricating into a variety of restorations, including inlays, onlays, crowns, veneers, bridges, implant abutments, copings and bridge frameworks. Various means of milling the mill blanks of the present invention may be employed to create custom-fit dental prosthesiss having a desired shape. It is preferable that the prosthesis be milled quickly without imparting undue damage. While milling the blank by hand using a hand-held tool or instrument is possible, preferably the prosthesis is milled by machine, including computer controlled milling equipment. An example of a hand-held tool that can be used to carve a prosthesis from a mill blank of the invention is the DREMEL MultiPro™ variable speed rotary tool with diamond points (Dremel, Inc.; Racine, Wis.). Preferred devices to create a prosthesis are CAD/CAM machines capable of milling a blank, such as machines sold under the tradenames Sirona CEREC 2, Dentronics DECIM or CadCam Ventures PROCAM.

By using a CAD/CAM milling device, the prosthesis can be fabricated efficiently and with precision. During milling, the contact area may be dry, or it may be flushed with or immersed in a lubricant. Alternatively, it may be flushed with an air or gas stream. Suitable liquid lubricants are well known, and include water, oils, glycerine, ethylene glycols, and silicones. After machine milling, some degree of finishing, polishing and adjustment may be necessary to obtain a custom fit in to the mouth and/or aesthetic appearance.

For cost and time efficiency, it is desirable to have the ability of rapidly milling a complete prosthesis from a crystalline ceramic mill blank within a short time period. The mill blanks of the present invention provide such a capability, where a restoration of a desired shape, such as a full crown, for example, can be milled in a period of less than about 3 hours. Preferably a complete prosthesis can be milled in less than about 2 hours; more preferably in less than about 1 hour; and most preferably in less than about ½ hour. Rapid millability is especially advantageous in instances where a patient desires to be treated in a single appointment and a practitioner has access to a CAD/CAM milling machine. In those situations, it is conceivable that the practitioner can make a complete prosthesis while a patient sits chairside.

A milled dental prosthesis can be attached to the tooth or bone structure with a wide variety of bonding agents. Examples include glass ionomer cement, resin cement, zinc phosphate, zinc polycarboxylate, compomer, or resin-modified glass ionomer cement.

Adhesion may be enhanced by coating the milled prosthesis with silica and using silane coupling agents. Alternatively, to enhance bonding, retentive grooves or undercuts may be carved into the bonding surfaces of the prosthesis.

The use of a light transmissive material for a mill blank allows external tailoring of the appearance of the restoration by modifying both the color of the luting or bonding agent, color/shading of the inner surface of the restoration. For example, use of certain types of luting or bonding composites or cements can provide coloration to or in combination with a prosthesis milled from a mill blank according to the invention. This can be accomplished through custom shading or color-matching, whereby a colored composition (cement, paste, gel, etc.) suitable for use in an oral environment is used to adhere the prosthesis to the underlying tooth structure. The result is that the appearance of the milled prosthesis will closely match the surrounding dentition. Preferred composites are available under the tradename 3M OPAL Luting Composite (3M Co., St. Paul, Minn.) and 3M RELYX ARC Adhesive Resin Cement. Alternatively, a color or shading composition may be used to add coloration or shading by coating or painting the composition directly onto the underlying structure of the prosthesis, or onto a surface of a milled prosthesis.

Optionally, additional material can be added to the milled prosthesis for various purposes including repair, correction, or enhancing esthetics. The additional material may be of one or more different shades or colors and may be material made from composite, ceramic, metal, glass or a glass ceramic such as feldspathic porcelain. In a preferred method, a light-cured composite is used. For example, a further use of the mill blanks of the present invention is to mill the blank into substructure, such as a coping or bridge framework, upon which additional material such as a composite or porcelain may be added, built-up or bonded, resulting in a highly esthetic restoration. This build up or addition may be performed by the practitioner or a laboratory equipped to provide such services. For example, in one aspect of the present invention, a practitioner may fabricate a substructure then consequently have a laboratory add material to create the final restoration.

Upon addition of material to the carved or milled blank, a practitioner or laboratory technician may choose or need to manually change the shape of the prosthesis. This re-work is generally performed to provide a custom fit into a patient's dentition. Optionally, or as a consequence of re-work, the practitioner or laboratory may choose to “finish” the outer surface of the milled blank. Finishing may include surface modifications such as polishing, painting, luting, buffing, grinding, glazing, and applying gloss or overcoat.

The crystalline ceramic mill blank of the invention may be provided in kit-form, where one or more blanks are placed into a multiple-unit kit, along with instructions for using the blanks. Preferably, a color-matching composition such as a luting or bonding agent is provided in a multiple-unit kit. A milling lubricant compatible with a milling process and the mill blank may also be provided in the multiple-unit kit.

Optionally, multiple shades of the mill blanks may be provided in a kit. For example, one each of a light shade, a medium shade, and a dark shade blank may be placed into a kit to provide a practitioner with blanks that can be milled into prostheses and readily blend in with a range of shades.

The following nonlimiting examples are given to illustrate the invention.

### EXAMPLES

Manufacturers of the ceramic material samples used in the examples are listed below in Table A. Abbreviations in parentheses are used to reference back from the examples to this list of manufacturers. When available, the block description and characteristics are taken from the manufacturer's product literature.

TABLE A

| | Block | |
|---|---|---|
| Manufacturer | Description | Block Characterisics |
| Ivoclar ProCAD (IPCAD) (Ivoclar | I12 block | leucite-reinforced ceramic |
| Aktiengesellschaft, Schaan, Liechtenstein) | | |
| Vita Mark II Vitabloc (VMV) (Vita | I12 | fine particle feldspar ceramic; |
| Zahnfabrik, Bad Säckingen, Germany). | | feldspar particles homogeneously |
| | | embedded in a glassy matrix |
| Ceradyne Transtar ™ TPA ™ | | translucent polycrystalline 99.9% |
| (CTTPA)(Ceradyne Inc, Costa Mesa, CA) | | pure Al2O3, sintered to nearly |
| | | full dense, pore-free condition |
| GE ™ Lucalox ™ (GEL)(General Electric | | polycrystalline translucent |
| Company, Richmond Heights, OH). | | aluminum oxide, 99.9% AL2O3, |
| | | essentially a single phase |
| | | material; glass-free structure |
| Vesuvius McDanel ™ alumina (VMT9A) | Type 998 | 99.8% Al2O3 |
| (Vesuvius McDanel, Beaver Falls, PA). | | |
| ZrO₂ single crystal (ZrO₂) (Alfa Aesar Co.) | | single crystal zirconium oxide |
| | | yttrium oxide, 100 orientation |
| Al₂O₃ single crystal (A1X) (Alfa Aesar Co.) | | single crystal alumina, random |
| | | orientation |
| Norton Prozyr ZrO₂ (NORTON) (Norton | | yttria-stabilized zirconia; fully |
| Desmarquest, Raleigh, NC) | | dense material made from |
| | | submicronic tetragonal grains |

Sample Preparation for Contrast Ratio

In Table 1 samples for Examples 1-14 were prepared as follows: Examples denoted “as-received” were tested as provided by the manufacturer, with no further treatment. For samples denoted “cut”; ceramic wafers with starting dimensions of 1.0±0.07 mm thick were cut at the maximum speed setting on a Buehler Isomet Saw (Lake Bluff, Ill.) using a type Buehler type 15-LC diamond wafering blade. No further treatment was done to the sample surfaces.

### Testing Procedures

### Contrast Ratio

ASTM-D2805-95 was modified to measure the contrast ratio for ceramic materials with thicknesses of approximately 1.0 mm. Ceramic wafers with two parallel flat surfaces and a thickness of 1.0±0.07 mm were prepared as described. Y-tristimulus values for the ceramic material wafers were measured on an Ultrascan XE Colorimeter with a ⅜ in aperture (Hunter Associates Labs, Reston, Va.) with separate white and black backgrounds. The D65 Illuminant was used with no filters for all measurements. A 10 degree angle of view was used. The Y-tristimulus values for the white and black substrates were 85.28 and 5.35, respectively. The contrast ratio, C, is calculated as the ratio of the reflectance of a material on a black substrate to that of an identical material on a white substrate. Reflectance is defined as equal to the Y-tristimulus value. Thus C=R_{B}/R_{W}, where R_{B}=reflectance of a ceramic wafer on a black substrate and R_{W}=of the same wafer on a white substrate.

### Flexural Strength

Test samples measuring 1.4×2.48×12 mm were milled on a Sirona CEREC 2 system using Version CS 1.12 of the operating software; the file for the bar specimen was retrieved by choosing tooth #1 and then pressing the softkey on the monitor. The samples were stored at room temperature and tested dry. A 3-point bend test configuration was employed, with a span of 10.0 mm; crosshead speed 0.75 mm/min (tested on Instron 4505, Instron Corp., Canton, Mass.). Flexural strength was calculated from the resulting trace of load versus time. Flexural Strength is reported in megapascal (Mpa).

### Examples1-14

TABLE 1
Contrast Ratio measurements

| | Sample | | Sample | |
|---|---|---|---|---|
| | Prep | | Thickness | Contrast |
| Example No. | Method | Material | (mm) | Ratio |
| Comparative 1 | As-received | Clear glass slide (Fisher) | 1.00 | 0.15 |
| 2 | As-received | A1X, polished both sides | 1.02 | 0.21 |
| Comparative 3 | As-received | Frosted glass slide (Fisher) | 1.00 | 0.23 |
| 4 | Cut | GEL | 0.97 | 0.39 |
| 5 | As-received | ZRO₂, frosted side to lens | 1.07 | 0.43 |
| 7 | As-received | ZRO₂, polished side to lens | 1.07 | 0.47 |
| 8 | Cut | CTTPA | 1.00 | 0.54 |
| 9 | Cut | CTTPA | 1.01 | 0.54 |
| Comparative | Cut | VMV | 1.00 | 0.59 |
| 10 | | | | |
| Comparative | Cut | IPCAD | 0.99 | 0.61 |
| 11 | | | | |
| Comparative | Cut | IPCAD | 1.06 | 0.63 |
| 12 | | | | |
| Comparative | Cut | VMT9A | 0.99 | 0.85 |
| 13 | | | | |
| Comparative 14 | Cut | NORTON | 1.05 | 0.98 |

### Examples 15-19

TABLE 2
Flexural strength

| | | Flexural Strength |
|---|---|---|
| Example No. | Material | (MPa) |
| 15 | CTTPA | 323 ± 12.4 |
| Comparative 16 | IPCAD | 116.0 ± 5.4 |
| Comparative 17 | VMV | 134.8 ± 13.8 |
| 18 | GEL | 342.5 ± 25.5 |
| 19 | VMT9A | 301.3 ± 19.7 |

### Examples 20-24

Second molar crowns for tooth 31 were milled using the Sirona™ CEREC™ 2 system, software version CS 1.12. A new set of diamond tools was used with each block of material. The total milling time, as displayed by the unit, was recorded. The volume milled was calculated by subtracting the volume of the crown from the total removed volume. This data is reported in Table 3. The indicated amount of Sirona™ Dentatec™ Milling Concentrate was used in the lubricant reservoir tank. Fresh lubricant was used for each milled sample.

TABLE 3
Dental milling results for tested material.

| | Dental Mill | | | Milled | |
|---|---|---|---|---|---|
| | Blank | Dentac Mill | Mill Time | Volume | |
| Example No. | Manufacturer | Fluid (ml) | (min:secs) | (mm³⁾ | Dimensions |
| Comparative 20 | IPCAD | 50 | 14:11 | 1146 | square, 12 × 10 × 15 mm |
| Comparative 21 | VMV | 25 | 13:44 | 1146 | square, 12 × 10 × 15 mm |
| 22 | CTTPA | 25 | 15:57 | 1155 | cylinder, 12 mm ht × 12 |
| | | | | | mm diameter |
| 23 | GEL | 50 | 18:03 | 1280 | square, 13 × 12 × 11 mm |
| Comparative 24 | VMT9A | 50 | 15:13 | 1199 | cylinder, 12 mm ht × |
| | | | | | 12.7 mm diameter |

### Examples 25-26

Examples 25 and 26 describe additional modifications that can be done to a ceramic crown to make the crown more aesthetic.

### Example 25

### Composite-on-Ceramic Crown

A coping was milled from Ceradyne Transtar™ TPA™ on the Sirona CEREC 2. 3M™ Restorative Z100 was bonded to the coping with 3M™ Singlebond™ Adhesive to fabricate a highly aesthetic crown.

### Example 26

### Porcelain-on-Ceramic Crown

A coping was milled from Ceradyne Transtar™ TPA™ on the Sirona™ CEREC™ 2. Vita™ Vitadur-N™ porcelain was applied to the coping using the manufacturer recommendations for buildup and firing to fabricate a highly aesthetic crown.

What is claimed is:

1. A crystalline ceramic dental mill blank having a Contrast Ratio value less than about 0.7.

2. The mill blank of claim 1 wherein the ceramic is a single crystal.

3. The mill blank of claim 1 wherein the ceramic is polycrystalline.

4. The mill blank of claim 3 wherein the ceramic is single-phase crystalline.

5. The mill blank of claim 3 wherein the ceramic is multi-phase crystalline.

6. The mill blank of claim 1 wherein the blank has a tooth-like shade.

7. The mill blank of claim 1 wherein the ceramic is aluminum oxide.

8. The mill blank of claim 1 wherein the ceramic is selected from the group consisting of magnesium-aluminum spinel, zirconium oxide, yttrium aluminum garnet, zirconium silicate, yttrium oxide and mullite

9. The mill blank of claim 1 wherein the blank has a Contrast Ratio value less than about 0.6.

10. The mill blank of claim 1 wherein the blank has a Contrast Ratio value less than about 0.5.

11. The mill blank of claim 1 wherein the blank, after milling into a Flexural Strength test sample, has a flexural strength greater than about 250 MPa.

12. The mill blank of claim 1 wherein the blank, after milling into a Flexural Strength test sample, has a flexural strength greater than about 350 MPa.

13. The mill blank of claim 1 wherein the blank, after milling into a Flexural Strength test sample, has a flexural strength greater than about 500 MPa.

14. The mill blank of claim 1 wherein the ceramic comprises less than about 5wt % glass.

15. The mill blank of claim 1 wherein the ceramic comprises less than about 2 wt % glass.

16. The mill blank of claim 1 wherein the ceramic is essentially free of oxynitride.

17. The mill blank of claim 1 wherein the blank includes a support stub.

18. A dental mill blank comprising at least 99% polycrystalline ceramic having at least 99% theoretical density and a Contrast Ratio value of less than about 0.7, wherein the blank, after milling into a Flexural Strength test sample, has a flexural strength greater than about 250 MPa.

19. The blank of claim 18 wherein the ceramic is selected from the group consisting of aluminum oxide, yttrium oxide, yttria-alumina garnet, and magnesium-aluminum spinel.

20. A method for making a dental prosthesis comprising the steps of:
a) providing a dental mill blank comprising crystalline ceramic having a Contrast Ratio less than about 0.7; and
b) carving the mill blank into a desired shape.

21. The method of claim 20 wherein the ceramic has a Contrast Ratio less than about 0.6.

22. The method of claim 20 wherein the ceramic has a Contrast Ratio less than about 0.5.

23. The method of claim 20 wherein the carved mill blank has a flexural strength greater than about 250 MPa.

24. The method of claim 20 wherein the carved mill blank has a flexural strength greater than about 350MPa.

25. The method of claim 20 wherein the carved mill blank has a flexural strength greater than about 500 MPa.

26. The method of claim 20 wherein the mill blank is carved into the desired shape in less than about 3 hours.

27. The method of claim 20 wherein the mill blank is carved into the desired shape in less than about 2 hours.

28. The method of claim 20 wherein the mill blank is carved into the desired shape in less than about 1 hour.

29. The method of claim 20 further comprising the step of:
c) adding additional material to the carved blank.

31. The method of claim 20 further comprising the steps of:
c) manually changing the shape of the carved blank and
d) finishing the outer surface of the carved blank.

32. The method of claim 20 wherein the carving is performed by a milling machine.

33. The method of claim 20 wherein the carving is performed by a hand-held instrument.

34. A method for using a dental prosthesis comprising the steps of:
a) providing a dental mill blank comprising crystalline ceramic having a Contrast Ratio less than about 0.7;
b) carving the mill blank into a desired shape; and
c) attaching the carved blank to tooth or bone structure.

35. The method of claim 34, wherein the carved blank is attached to the tooth or bone structure with a color-matching bonding agent.

36. The method of claim 34 further comprising an interim step of:
a) applying a color-matching composition onto a the tooth or bone structure prior to placing the carved blank onto the tooth structure.

37. A multiple-unit kit comprising a crystalline ceramic dental mill blank having a Contrast Ratio less than about 0.7 and instructions for using the mill blank.

38. The kit of claim 37 further comprising a color-matching composition suitable for use in the oral environment.

39. The kit of claim 37 further comprising a bonding agent.

40. The kit of claim 37 further comprising a milling lubricant.

41. A crystalline ceramic dental prosthesis having a Contrast Ratio value less than about 0.7.

42. The prosthesis of claim 41 wherein the ceramic is a single crystal.

43. The prosthesis of claim 41 wherein the ceramic is polycrystalline.

44. The prosthesis of claim 41 wherein the ceramic is single-phase crystalline.

45. The prosthesis of claim 41 wherein the ceramic is multi-phase crystalline.

46. The prosthesis of claim 41 wherein the ceramic is selected from the group consisting of aluminum oxide, magnesium-aluminum spinel, zirconium oxide, yttrium aluminum garnet, zirconium silicate, yttrium oxide and mullite.

47. The prosthesis of claim 41 having a flexural strength greater than about 250 MPa.

48. The prosthesis of claim 41 wherein the ceramic comprises less than about 5wt % glass.

49. The prosthesis of claim 41 wherein the ceramic is essentially free of oxynitride.
